(19) United States
(12) Patent Application Publication
(10) Pub. No.: US 2025/0392068 A1
(43) Pub. Date: Dec. 25, 2025

(54) CONNECTOR ASSEMBLY AND CABLE END CONNECTOR

(71) Applicant: Bellwether Electronic Corp., Taoyuan City (TW)

(72) Inventors: Hsing-Yu LEE, Taoyuan City (TW); Tai Ching SUNG, Taoyuan City (TW); Ching-Hsiang CHANG, Taoyuan City (TW)

(21) Appl. No.: 19/241,414

(22) Filed: Jun. 18, 2025

Related U.S. Application Data
(60) Provisional application No. 63/663,701, filed on Jun. 25, 2024.

(30) Foreign Application Priority Data
May 14, 2025 (TW) 114118149

(51) Int. Cl. H01R 13/436; H01R 12/70; H01R 12/75; H01R 13/629

(52) U.S. Cl. CPC H01R 13/4361; H01R 12/7011; H01R 12/75; H01R 13/629

(57) ABSTRACT

A connector assembly includes a first connector, a second connector, and a first plug. The first connector includes a first housing, a conductive terminal, and a first engaging structure. The first housing has a chamber. The conductive terminal includes a cylindrical structure partially located in the chamber. The first engaging structure is disposed on an outer surface of the first housing. The two connectors can be coupled along a mating direction. The second connector includes a second housing, a busbar terminal, and a second engaging structure. The second housing is able to be partially accommodated in the chamber. The second housing has a channel and a positioning slot communicating with the channel. The busbar terminal is located in the channel of the second housing. The second engaging structure is engaged with the first engaging structure. The first plug is located in the positioning slot.

### CROSS-REFERENCE TO RELATED APPLICATION

This application claims priority to U.S. Provisional Application Ser. No. 63/663,701 filed Jun. 25, 2024, and Taiwan Application Serial Number 114118149, filed May 14, 2025, the disclosures of which are incorporated herein by reference in their entireties.

### BACKGROUND

### Field of Invention

The present invention relates to a connector assembly and a cable end connector.

### Description of Related Art

In general, electrical connection between a cable and a circuit board is achieved through a connector. For example, the cable may be provided with a cable end connector, and the circuit board end may also be provided with a board end connector that matches the cable end connector.

However, with the increasing demand for conducting large currents, the quantity, volume, and weight of the cable also increase. This raises the risk that the cable end connector and the board end connector may fail to maintain a reliable electrical connection. In addition, the conductive terminals on the cable end connector may be pulled off by the cable. Accordingly, how to enhance the stable connection between the cable end connector and the board end connector has become an urgent problem to be solved.

Therefore, how to propose a connector assembly and a cable end connector that can solve the aforementioned problems is one of the problems that the industry is currently eager to invest in research and development resources to solve.

### SUMMARY

In view of this, one purpose of the present disclosure is to provide a connector assembly and a cable end connector that can solve the aforementioned problems.

In order to achieve the above objective, in accordance with an embodiment of the present disclosure, a connector assembly includes a first connector, a second connector, and a first plug. The first connector includes a first housing, a conductive terminal, and a first engaging structure. The first housing has a chamber. The conductive terminal includes a cylindrical structure. The cylindrical structure is partially located in the chamber of the first housing. The first engaging structure is disposed on an outer surface of the first housing. The second connector is configured to be coupled to the first connector along a mating direction. The second connector includes a second housing, a busbar terminal, and a second engaging structure. The second housing is able to be partially accommodated in the chamber. The second housing has a channel and a positioning slot communicating with the channel. The busbar terminal is located in the channel of the second housing and includes a coupling portion, a stepping portion, and a connecting portion. The coupling portion has an accommodating slot. The conductive terminal passes through the accommodating slot of the busbar terminal. The connecting portion is plate-shaped. The stepping portion is located between the coupling portion and the connecting portion. The second engaging structure is engaged with the first engaging structure. The first plug is located in the positioning slot and is adjacent to the stepping portion.

In one or more embodiments of the present disclosure, the first housing further includes securing portions located on two sides of the first housing. The securing portion has a securing hole.

In one or more embodiments of the present disclosure, the first housing further includes a securing portion located on two sides of the first housing. A portion of the securing portion is located on a centerline of the first housing. The centerline is perpendicular to the mating direction.

In one or more embodiments of the present disclosure, the first housing further has a recessed portion communicating with the chamber. The conductive terminal includes a middle portion and a pin. The middle portion is located in the recessed portion of the first housing and has a guiding furrow. The cylindrical structure extends from the middle portion along the mating direction. The pin is disposed on the middle portion.

In one or more embodiments of the present disclosure, the first housing further includes a guiding stick located in the recessed portion. The guiding stick is located in the guiding furrow of the middle portion.

In one or more embodiments of the present disclosure, the stepping portion has an inclined surface.

In one or more embodiments of the present disclosure, the first plug includes a cross bar, an elastic portion, and a bulge. The cross bar is accommodated in the positioning slot and blocks the busbar terminal. The elastic portion protrudes from a middle section of the cross bar and includes a fixed portion connected to the cross bar, a free portion connected to the fixed portion, a toggle latch disposed at an end of the free portion, and a protruding portion disposed on the toggle latch and located on a side of the free portion away from the fixed portion. The protruding portion is engaged with an inner surface of the second housing. The bulge is disposed on a side of the fixed portion of the elastic portion away from the free portion and protrudes from the fixed portion. The fixed portion and the free portion extend in parallel and the fixed portion and the free portion define a space therebetween.

In one or more embodiments of the present disclosure, the connector assembly further includes a second plug located in an inserting hole of the first housing and abutting against the conductive terminal.

In one or more embodiments of the present disclosure, the first housing includes a first housing main body and a tube body connected to the first housing main body. The chamber is located in the first housing main body. The first housing further has a recessed portion located in the tube body. The inserting hole runs through the tube body and communicates with the recessed portion.

In one or more embodiments of the present disclosure, the conductive terminal further includes a rear end portion, a front end portion, a first convex ring, and a second convex ring. The rear end portion is located on a side of the conductive terminal away from the second housing. The front end portion includes the cylindrical structure and is connected to the rear end portion. The front end portion is located on a side of the conductive terminal close to the second housing. The first convex ring and the second convex ring surround the front end portion. The first convex ring and the second convex ring are separated from each other. The second plug is partially located between the first convex ring and the second convex ring.

In one or more embodiments of the present disclosure, the first housing further includes a cantilever and a fringing portion. The cantilever is disposed on the outer surface of the first housing and includes a fixed end and a free end. The fringing portion surrounds the first housing and is separated from the cantilever. The inserting hole is located between the cantilever and the fringing portion.

In one or more embodiments of the present disclosure, the second plug includes a cross bar, an inserting portion, and a protruding portions. The cross bar is accommodated between the cantilever and the fringing portion. The inserting portion protrudes from a middle section of the cross bar and passes through the inserting hole. The protruding portion is located at both ends of the cross bar and protrudes from the cross bar. The protruding portion is engaged with the free end of the cantilever.

In one or more embodiments of the present disclosure, the second housing further includes a cover body. The second engaging structure is located on the cover body.

In order to achieve the above objective, in accordance with an embodiment of the present disclosure, a cable end connector includes a housing, a terminal, a cover body, and an engaging structure. The housing includes a first portion accommodated in a chamber and a second portion extending perpendicularly from the first portion. The terminal is located in the housing. The cover body is engaged with the housing. The engaging structure is disposed on the cover body and includes an elastic arm capable of seesawing relative to an outer surface of the housing and a hook located at an end of the elastic arm.

In one or more embodiments of the present disclosure, the cable end connector further includes a pull tab connected to the cover body. An end of the pull tab is connected to the engaging structure.

In one or more embodiments of the present disclosure, the cover body includes a pull tab guiding portion. The pull tab passes through the pull tab guiding portion to form at least two segments extending in different directions.

In one or more embodiments of the present disclosure, the cover body includes a guiding beam separating the pull tab guiding portion into a first perforation and a second perforation. A strip portion of the pull tab enters into the first perforation from an upper surface of the cover body, extends below the guiding beam, and exits via the second perforation.

In one or more embodiments of the present disclosure, the terminal includes a coupling portion, a stepping portion, and a connecting portion. The stepping portion is connected to the coupling portion and the connecting portion, and the stepping portion is located between the coupling portion and the connecting portion. The coupling portion has an accommodating slot. A top surface of the connecting portion is higher than a top surface of the coupling portion.

In one or more embodiments of the present disclosure, the connecting portion has a cable slot. The cable slot has an opening such that a portion of a cable is capable of entering the cable slot through the opening.

In summary, in the connector assembly of the present disclosure, since the second engaging structure located on the second housing is engaged with the first engaging structure located on the first housing, the first connector and the second connector can be coupled to each other. In the connector assembly of the present disclosure, since the first plug is inserted into the positioning slot of the second housing and abuts against the busbar terminal, and the height of the coupling portion of the busbar terminal is greater than the height of the connecting portion, the busbar terminal is blocked by the first plug, thereby preventing the user from unintentionally pulling the busbar terminal coupled to the cable out of the second housing. In the connector assembly of the present disclosure, since the second plug is inserted into the inserting hole of the first housing and is partially located between the first convex ring and the second convex ring of the conductive terminal, the conductive terminal is blocked by the second plug, thereby preventing the user from unintentionally pulling the conductive terminal coupled to the cable out of the first housing. In the connector assembly of the present disclosure, since the step is formed at the bottom portion of the first housing, the circuit board can be partially accommodated in a recess formed by the step, thereby reducing the height of the connector assembly relative to the circuit board and achieving a space-saving effect. In the connector assembly of the present disclosure, since the end of the pull tab is fixed to the pressing portion of the second engaging structure, and the second engaging structure is disposed on the cover body of the second housing, when the user intends to remove the second connector from the first connector, the second engaging structure can be disengaged from the engaging hole located on the first housing by pulling the pull tab, therefore it is more convenient to disconnect the two connectors. In the connector assembly of the present disclosure, since the busbar terminal includes the stepping portion connected to and located between the coupling portion and the connecting portion, the stress applied to the busbar terminal can be reduced, thereby enhancing the structural strength of the busbar terminal. Overall, the connector assembly of the present disclosure can achieve ease of operation and provide a stable structure for the entire connector assembly.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector assembly in accordance with an embodiment of the present disclosure;

FIG. 2 is an exploded view of a connector assembly in accordance with an embodiment of the present disclosure;

FIG. 3 is a perspective view of a first connector in accordance with an embodiment of the present disclosure;

FIG. 4 is a perspective view of a first housing in accordance with an embodiment of the present disclosure;

FIG. 5 is a perspective view of a conductive terminal in accordance with an embodiment of the present disclosure;

FIG. 6 is a perspective view of a second connector in accordance with an embodiment of the present disclosure;

FIG. 7 is a perspective view of a busbar terminal in accordance with an embodiment of the present disclosure;

FIG. 8 is a perspective view of a busbar terminal in accordance with an embodiment of the present disclosure;

FIG. 9 is a sided view of a busbar terminal in accordance with an embodiment of the present disclosure;

FIG. 10 is a rear view of a busbar terminal in accordance with an embodiment of the present disclosure;

FIG. 11 is a perspective view of a plug in accordance with an embodiment of the present disclosure;

FIG. 12 is a perspective view of a plug in accordance with an embodiment of the present disclosure;

FIG. 13 is a top view of a connector assembly in accordance with an embodiment of the present disclosure;

FIG. 14 is a cross-sectional view of the connector assembly based on a section 14-14 of FIG. 13 in accordance with an embodiment of the present disclosure;

FIG. 15 is a cross-sectional view of the connector assembly based on a section 15-15 of FIG. 13 in accordance with an embodiment of the present disclosure;

FIG. 16 is a perspective view of a first connector in accordance with an embodiment of the present disclosure;

FIG. 17 is a perspective view of a connector assembly in accordance with an embodiment of the present disclosure;

FIG. 18 is an exploded view of a connector assembly in accordance with an embodiment of the present disclosure;

FIG. 19 is a perspective view of a first housing in accordance with an embodiment of the present disclosure;

FIG. 20 is a perspective view of a first housing in accordance with an embodiment of the present disclosure;

FIG. 21 is a perspective view of a first housing in accordance with an embodiment of the present disclosure;

FIG. 22 is a top view of a first housing in accordance with an embodiment of the present disclosure;

FIG. 23 is a perspective view of a plug in accordance with an embodiment of the present disclosure;

FIG. 24 is a perspective view of a plug in accordance with an embodiment of the present disclosure;

FIG. 25 is a sided view of a connector assembly in accordance with an embodiment of the present disclosure;

FIG. 26A and FIG. 26B are perspective cross-sectional views of the connector assembly based on a section 26A-26A and a section 26B-26B of FIG. 25, respectively, in accordance with an embodiment of the present disclosure;

FIG. 27 is a perspective view of a connector assembly in accordance with an embodiment of the present disclosure;

FIG. 28 is an exploded view of a connector assembly in accordance with an embodiment of the present disclosure;

FIG. 29 is a perspective view of a busbar terminal in accordance with an embodiment of the present disclosure;

FIG. 30 is a rear view of a busbar terminal in accordance with an embodiment of the present disclosure;

FIG. 31 is a sided view of a busbar terminal in accordance with an embodiment of the present disclosure;

FIG. 32 is a top view of a connector assembly in accordance with an embodiment of the present disclosure;

FIG. 33 is a cross-sectional view of the connector assembly based on a section 33-33 of FIG. 32 in accordance with an embodiment of the present disclosure; and

FIG. 34 is a cross-sectional view of the connector assembly based on a section 34-34 of FIG. 32 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

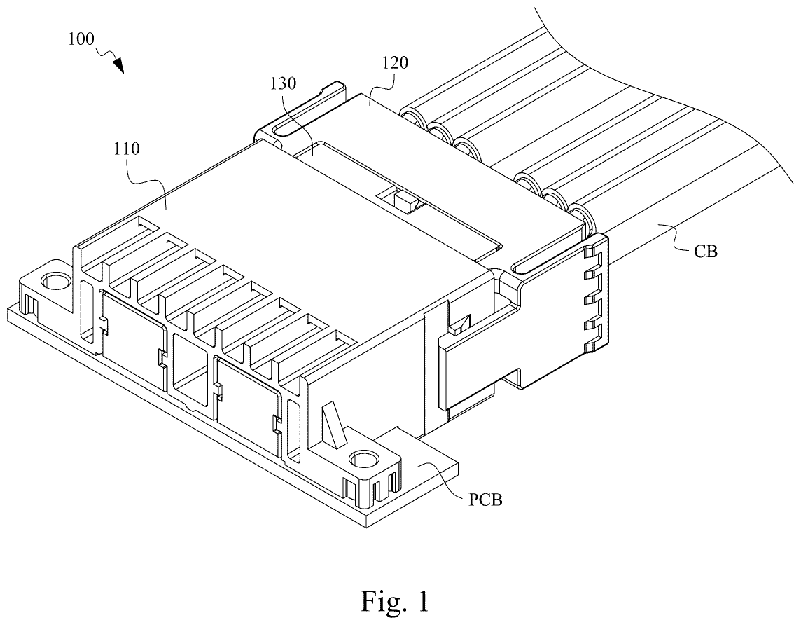

Reference is made to FIG. 1. FIG. 1 is a perspective view of a connector assembly 100 in accordance with an embodiment of the present disclosure. As shown in FIG. 1, in this embodiment, the connector assembly 100 includes a first connector 110 (e.g., a board end connector) and a second connector 120 (e.g., a cable end connector). The first connector 110 is disposed on a circuit board PCB. The second connector 120 is coupled to the first connector 110. Specifically, the second connector 120 is coupled to the first connector 110 along a mating direction that is parallel to the circuit board PCB, and the first connector 110 has a cavity configured to accommodate a portion of the second connector 120. In some embodiments, the second connector 120 is engaged with the first connector 110. A cable CB is connected to the second connector 120. Specifically, the cable CB is connected to an end of the second connector 120 that is away from the first connector 110.

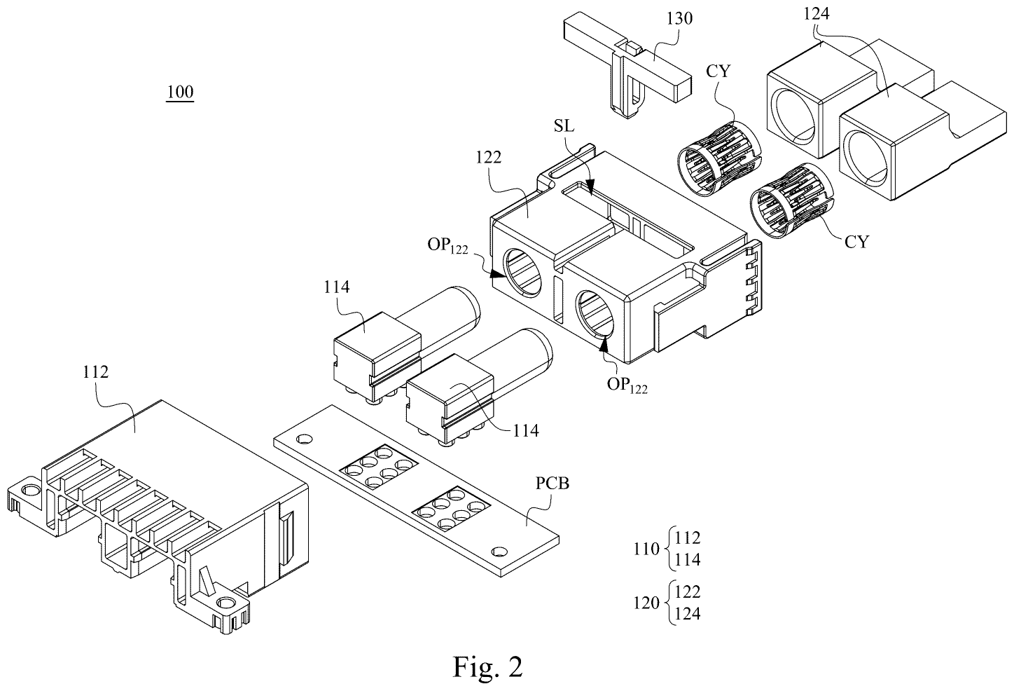

Reference is made to FIG. 2. FIG. 2 is an exploded view of a connector assembly 100 in accordance with an embodiment of the present disclosure. As shown in FIG. 2, in this embodiment, the first connector 110 includes a first housing 112 and a conductive terminal 114. The first housing 112 is configured to accommodate the conductive terminal 114. The second connector 120 includes a second housing 122 and a busbar terminal 124. The second housing 122 is configured to accommodate the busbar terminal 124. The second housing 122 further has an opening OP₁₂₂. The opening OP₁₂₂ is located at an end of the second housing 122 close to the first housing 112. In some embodiments, the second connector 120 further includes a plug 130, and the second housing 122 has a positioning slot SL on a top plate of the second housing 122. The plug 130 is detachably mounted in the positioning slot SL. The contour of the positioning slot SL on the top plate of the second housing 122 conforms to a portion of the plug 130, such that the plug 130 can pass through. As shown in FIG. 2, the connector assembly 100 further includes a crown band CY. The crown band CY is configured to assist and enhance the electrical connection between the conductive terminal 114 and the busbar terminal 124.

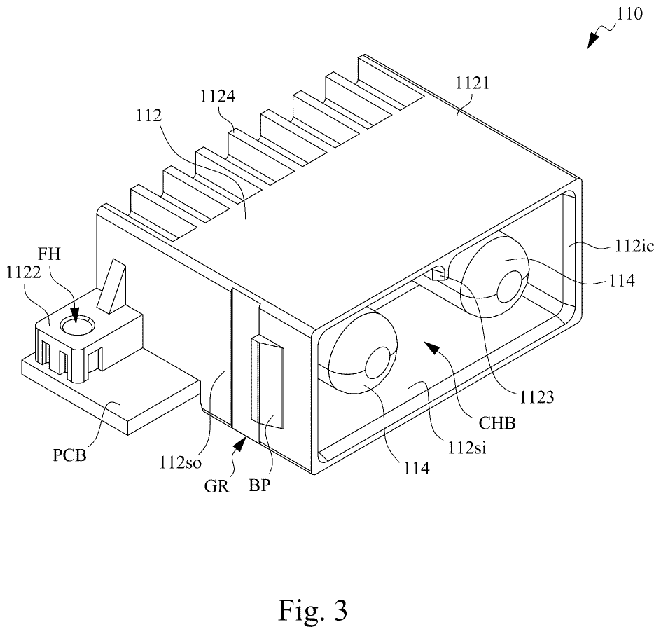

Reference is made to FIG. 3. FIG. 3 is a perspective view of a first connector 110 in accordance with an embodiment of the present disclosure. As shown in FIG. 3, in this embodiment, the first housing 112 further includes a first housing main body 1121, a securing portion 1122, a guiding rail 1123, a dissipation fin 1124, and a first engaging structure BP. The first housing main body 1121 further has a chamber CHB. The conductive terminal 114 is partially located in the chamber CHB. The securing portion 1122 is located on the left and right side edges of the first housing 112. In this embodiment, the securing portion 1122 is located at the two lateral edges of the first housing 112 away from the chamber CHB. The securing portion 1122 is disposed on side plates of the first housing 112 and protrudes from an outer surface 112so of the first housing 112. The securing portion 1122 has a securing hole FH configured to allow an additional fixing part (not shown) to pass through, thereby fixing the first housing main body 1121 to the circuit board PCB. The guiding rail 1123 is disposed in the chamber CHB and elongated along the aforementioned mating direction. The second housing 122 includes a recess corresponding to the guiding rail 1123 (referring to FIG. 2). The dissipation fin 1124 is disposed on a top plate of the first housing 112 and is located on a side of the first housing 112 away from the chamber CHB. In this embodiment, the first engaging structure BP is a bump disposed on the outer surface 112so of the first housing 112 and configured to allow the second housing 122 to be engaged with the first housing 112.

The chamber CHB further has an inclined surface 112ic at the opening. The inclined surface 112ic surrounds a periphery of the opening, and the inclined surface 112ic extends inward from an outermost edge of the opening, thereby the size of the chamber CHB is gradually reduced from the opening. In other words, when the second housing 122 is inserted toward the chamber CHB (i.e., coupled to the first housing 112), the inclined surface 112ic can guide the second housing 122. The first housing 112 further has a groove GR. The groove GR is recessed from the outer surface 112so of the first housing 112, and the groove GR is adjacent to the first engaging structure BP.

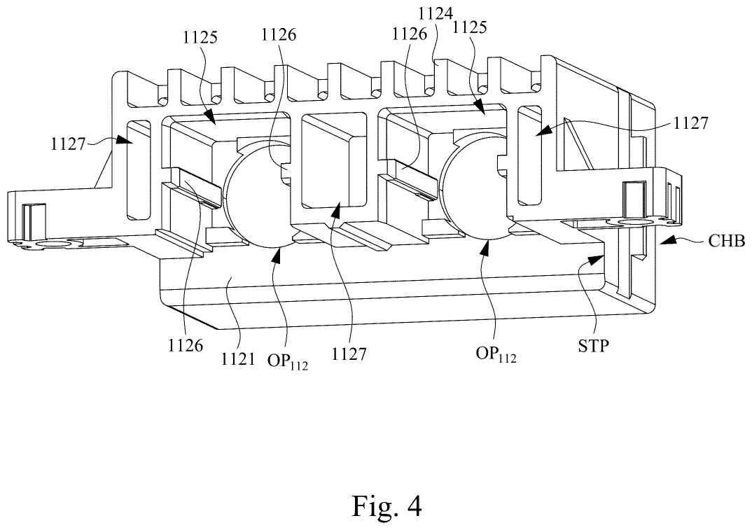

Reference is made to FIG. 4. FIG. 4 is a perspective view of a first housing 112 in accordance with an embodiment of the present disclosure. As shown in FIG. 4, in this embodiment, the first housing 112 further includes a recessed portion 1125, a guiding stick 1126, and a cooling hole 1127. The first housing 112 also has an opening OP₁₁₂ and a step STP. The recessed portion 1125 communicates with the chamber CHB via the opening OP₁₁₂. The guiding stick 1126 is located in the recessed portion 1125 and elongated along the mating direction. The cooling hole 1127 is recessed from the first housing main body 1121 and located between a plurality of recessed portions 1125. In some embodiments, the dissipation fin 1124 is located over the recessed portions 1125 and the cooling hole 1127. The step STP is located at a bottom portion of the first housing 112. Specifically, the step STP forms a vertical offset at the bottom portion of the first housing 112, such that a portion of the circuit board PCB can be accommodated in the step STP.

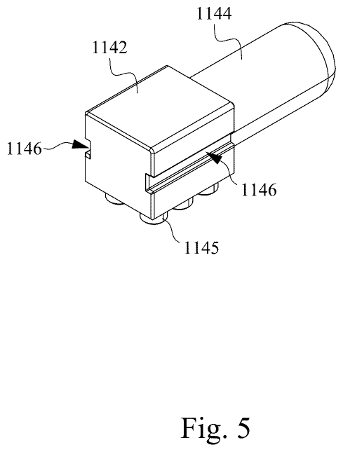

Reference is made to FIG. 5. FIG. 5 is a perspective view of a conductive terminal 114 in accordance with an embodiment of the present disclosure. As shown in FIG. 5, in this embodiment, the conductive terminal 114 includes a middle portion 1142, a front end portion 1144, and a plurality of pins 1145. The conductive terminal 114 also has a guiding furrow 1146. The middle portion 1142 is located in the recessed portion 1125 of the first housing 112. The front end portion 1144 extends from the middle portion 1142 and passes through the opening OP₁₁₂ so as to be exposed in the chamber CHB. In this embodiment, the front end portion 1144 includes a cylindrical structure. The pins 1145 are disposed on the middle portion 1142. The conductive terminal 114 is electrically connected to the circuit board PCB by the pins 1145. The guiding furrow 1146 is recessed from the middle portion 1142 and extends along the mating direction. The guiding stick 1126 is located in the guiding furrow 1146, such that the conductive terminal 114 is assembled into the first housing 112 along the mating direction by mating the guiding furrow 1146 and the guiding stick 1126. In some embodiments, the middle portion 1142 has a substantially cuboid or cubic shape. In some embodiments, the front end portion 1144 has a substantially cylindrical shape. However, the present disclosure is not intended to limit the shape of the middle portion 1142 and/or the front end portion 1144.

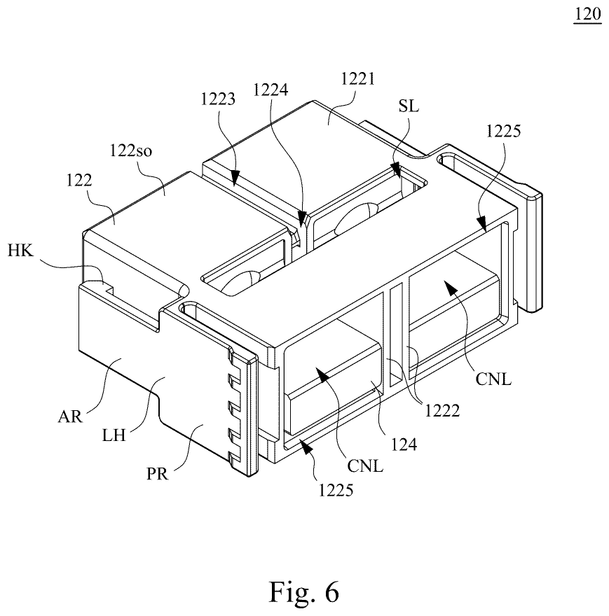

Reference is made to FIG. 6. FIG. 6 is a perspective view of a second connector 120 in accordance with an embodiment of the present disclosure. As shown in FIG. 6, in this embodiment, the second housing 122 further includes a second housing main body 1221, a partitioning wall 1222, and a second engaging structure LH. The second housing 122 also has a guiding groove 1223, a limiting groove 1224, a cable end opening 1225, and a channel CNL. The channel CNL is defined by the second housing main body 1221. The channel CNL communicates with the positioning slot SL. The partitioning wall 1222 divides the second housing 122 into a plurality of channels CNL. The guiding groove 1223 is recessed from the top plate of the second housing 122 and elongated along the mating direction. The guiding groove 1223 communicates with the positioning slot SL and corresponds to the guiding rail 1123 of the first housing 112. The second housing 122 is mated toward the chamber CHB of the first housing 112 through guidance of the guiding groove 1223 and the guiding rail 1123. The limiting groove 1224 is recessed from the second housing main body 1221 and located in the positioning slot SL. The cable end opening 1225 exposes the busbar terminal 124 located in the channel CNL. Specifically, as shown in FIG. 2 and FIG. 6, the cable end opening 1225 is located at an end of the second housing 122 away from the first housing 112.

The second engaging structure LH is disposed on an outer surface 122so of the second housing 122 and is configured to be engaged with the first engaging structure BP. The second engaging structure LH is, for example, a latch structure and includes an elastic arm AR, a pressing portion PR, and a hook HK. The elastic arm AR is disposed on the second housing 122 and is capable of seesawing relative to the outer surface 122so of the second housing 122. The pressing portion PR is located at an end of the elastic arm AR. The hook HK is located at the other end of the elastic arm AR. In some embodiments, a width W_{PR} of the pressing portion PR is greater than a width W_{AR} of the elastic arm AR. In other words, the pressing portion PR is wider than the elastic arm AR.

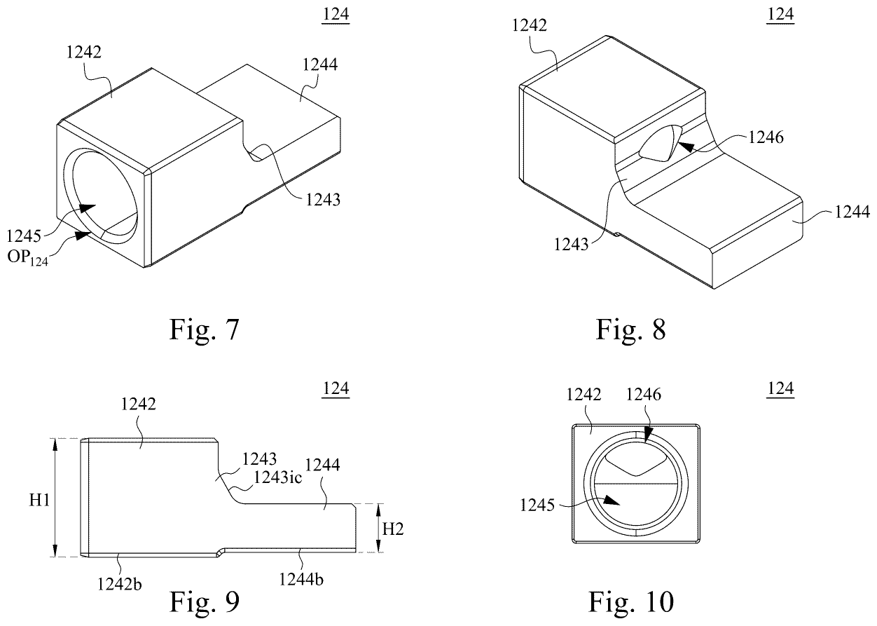

Reference is made to FIG. 7 to FIG. 10. FIG. 7 is a perspective view of a busbar terminal 124 in accordance with an embodiment of the present disclosure. FIG. 8 is a perspective view of a busbar terminal 124 in accordance with an embodiment of the present disclosure. FIG. 9 is a sided view of a busbar terminal 124 in accordance with an embodiment of the present disclosure. FIG. 10 is a rear view of a busbar terminal 124 in accordance with an embodiment of the present disclosure. As shown in FIG. 7 and FIG. 8, in this embodiment, the busbar terminal 124 includes a coupling portion 1242, a stepping portion 1243, and a connecting portion 1244. The coupling portion 1242 has an accommodating slot 1245, and a crown band CY is disposed in the accommodating slot 1245. The accommodating slot 1245 aligns with the opening OP₁₂₂ and is configured to allow the conductive terminal 114 to pass through the opening OP 122 and enter the accommodating slot 1245, thereby the conductive terminal 114 is electrically connected with the busbar terminal 124 via the crown band CY. The stepping portion 1243 is connected with the coupling portion 1242 and the connecting portion 1244. The stepping portion 1243 is located between the coupling portion 1242 and the connecting portion 1244. A step is formed between a side surface (e.g., the top surface) of the coupling portion 1242 and the corresponding surface of the connecting portion 1244, thereby the stepping portion 1243 is formed. That is, the coupling portion 1242 has a height H1, the connecting portion 1244 has a height H2, and the height H1 is greater than height H2. In other words, an end of the stepping portion 1243 is connected to a side surface of the coupling portion 1242, and the other end of the stepping portion 1243 is connected to a side surface of the connecting portion 1244. In some embodiments, the busbar terminal 124 has a through hole 1246. An end of the through hole 1246 communicates with the accommodating slot 1245, and the other end of the through hole 1246 is located on the stepping portion 1243. After electroplating the busbar terminal 124, plating liquid can be discharged via the through hole 1246. As shown in FIG. 9, the stepping portion 1243 has an inclined surface 1243ic, and the inclined surface 1243ic is connected to a top surface of the connecting portion 1244. A bottom surface 1242b of the coupling portion 1242 and a bottom surface 1244b of the connecting portion 1244 may be flush or stepped.

In some embodiments, the coupling portion 1242 has a substantially cuboid shape. In some embodiments, the connecting portion 1244 is plate-shaped. However, the present disclosure is not intended to limit the shape of the coupling portion 1242 and the connecting portion 1244.

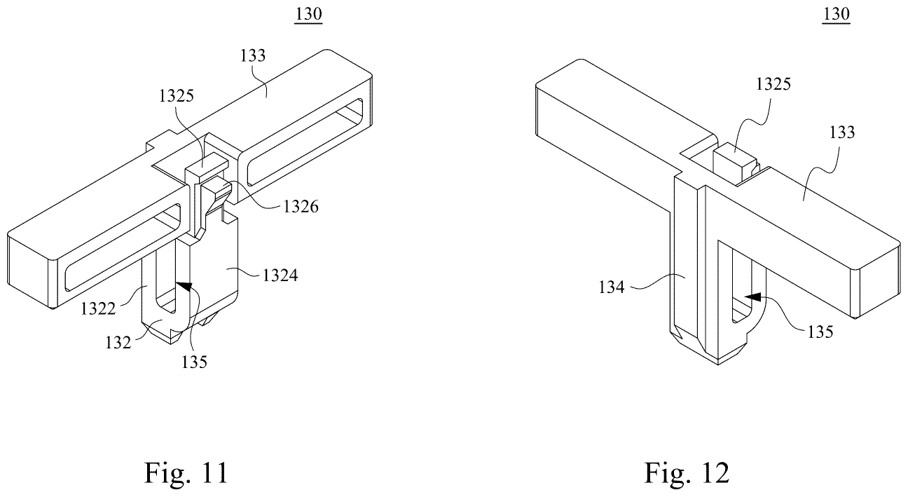

Reference is made to FIG. 11 and FIG. 12. FIG. 11 is a perspective view of a plug 130 in accordance with an embodiment of the present disclosure. FIG. 12 is a perspective view of a plug 130 in accordance with an embodiment of the present disclosure. As shown in FIG. 11 and FIG. 12, in this embodiment, the plug 130 includes an elastic portion 132, a cross bar 133, and a bulge 134. The plug 130 also defines a space 135. The elastic portion 132 protrudes from a middle section of the cross bar 133. The elastic portion 132 includes a fixed portion 1322, a free portion 1324, a toggle latch 1325, and a protruding portion 1326. The fixed portion 1322 is connected to the cross bar 133. An end of the free portion 1324 is connected to the fixed portion 1322, and the other end of the free portion 1324 serves as a free end extending toward the cross bar 133. The toggle latch 1325 is located on a side of the free end of the free portion 1324, and the toggle latch 1325 is flush with or slightly higher than a top surface of the cross bar 133. The protruding portion 1326 is located on a side of the free end of the free portion 1324 that is away from the fixed portion 1322. The bulge 134 is disposed on a side of the fixed portion 1322 away from the free portion 1324, and the bulge 134 protrudes from the fixed portion 1322. The bulge 134 is mated with the limiting groove 1224 of the second housing 122, such that the plug 130 can be guided when the plug 130 is inserted into the positioning slot SL. In some embodiments, the fixed portion 1322 and the free portion 1324 extend in parallel. The space 135 is defined between the fixed portion 1322 and the free portion 1324. The space 135 serves as an operation space when the free portion 1324 is bent by external force. In some embodiments, the plug 130 is T-shaped.

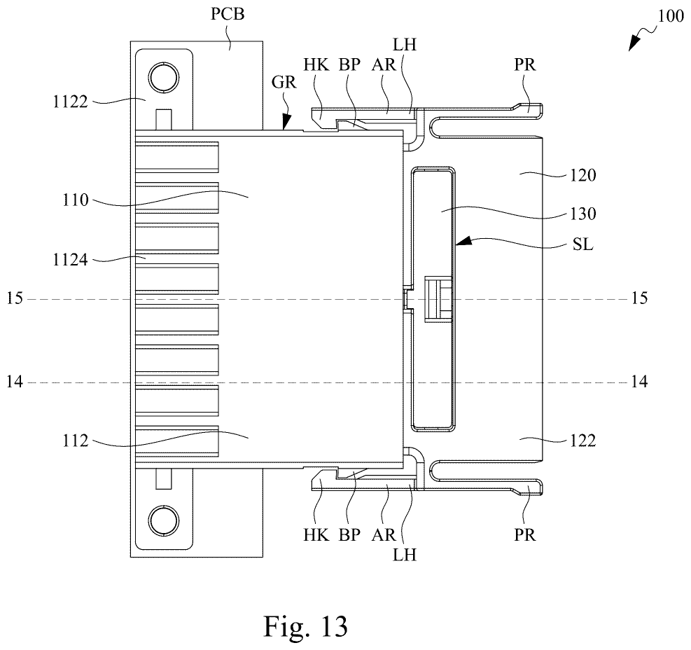

Reference is made to FIG. 13. FIG. 13 is a top view of a connector assembly 100 in accordance with an embodiment of the present disclosure. As shown in FIG. 13, in this embodiment, when the first connector 110 and the second connector 120 are coupled to each other, the second engaging structure LH disposed on the second housing 122 is engaged with the first engaging structure BP disposed on the first housing 112, and the hook HK is accommodated in the groove GR. The configuration of the groove GR allows an overall width of the second housing 122 to be reduced, thereby the volume occupied by the connector assembly 100 can be reduced.

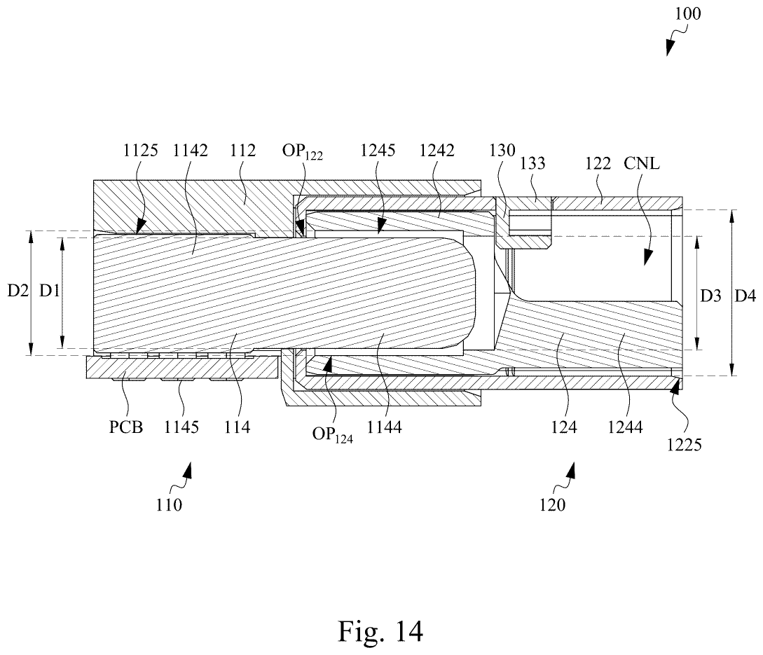

Reference is made to FIG. 14. FIG. 14 is a cross-sectional view of the connector assembly 100 based on a section 14-14 of FIG. 13 in accordance with an embodiment of the present disclosure. For simplicity, the crown band CY is omitted in FIG. 14. As shown in FIG. 14, the cable end opening 1225 located at an end of the channel CNL away from the first housing 112 has a height D4, and the height D4 is slightly greater than or equal to a height of the coupling portion 1242. After the busbar terminal 124 is installed into the channel CNL via the cable end opening 1225, the plug 130 is inserted into the positioning slot SL of the second housing 122. At this time, the cross bar 133 of the plug 130 is accommodated in the positioning slot SL and is adjacent to or abuts against the stepping portion 1243, so as to limit the movement of the busbar terminal 124. Thus, the busbar terminal 124 is blocked by the cross bar 133 and prevented from detaching from the channel CNL along the direction opposite to the mating direction. The opening OP₁₂₂ of the channel CNL has a diameter D1, and the opening OP 124 of the accommodating slot 1245 has a diameter D2, where the diameter D1 is smaller than the diameter D2. This configuration prevents the crown band CY, which is installed in the accommodating slot 1245, from being detached through the opening OP₁₂₂. An aperture of the other end of the accommodating slot 1245 away from the opening OP₁₂₂ may be slightly narrowed, and the aperture has a diameter D3, that is, the diameter D2 is greater than the diameter D3. This restricts the position of the crown band CY within the accommodating slot 1245. The middle portion 1142 of the conductive terminal 114 is accommodated in the recessed portion 1125, and the front end portion 1144 passes through the opening OP₁₂₂ and is located in the accommodating slot 1245. A diameter of the front end portion 1144 is slightly less than the opening OP₁₂₂ of the channel CNL. When the first connector 110 and the second connector 120 are coupled to each other, the front end portion 1144 enters the accommodating slot 1245 via the opening OP₁₂₂. At this time, the conductive terminal 114 is electrically connected to the busbar terminal 124 via the crown band CY.

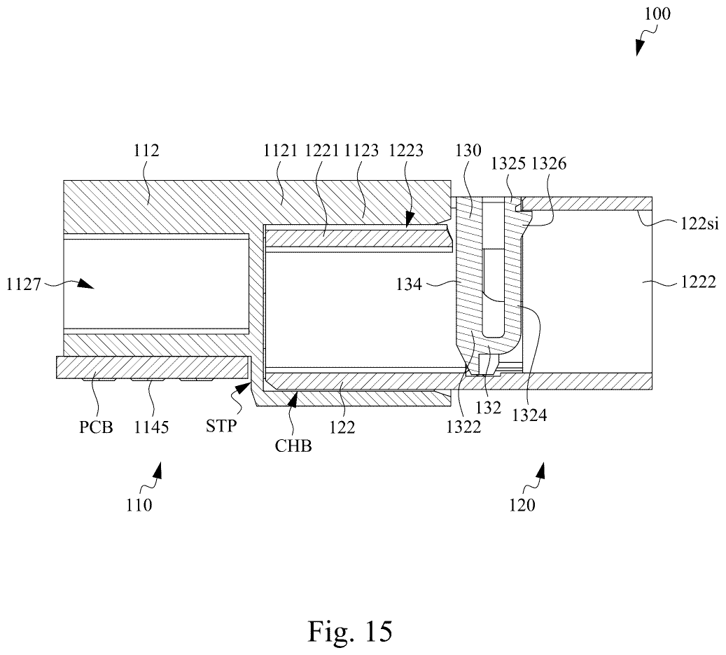

Reference is made to FIG. 15. FIG. 15 is a cross-sectional view of the connector assembly 100 based on a section 15-15 of FIG. 13 in accordance with an embodiment of the present disclosure. When the plug 130 is installed in the positioning slot SL, the protruding portion 1326 of the plug 130 is engaged with an inner surface 122si of the second housing 122 (i.e., a side surface of the channel CNL). At this time, the plug 130 restricts the movement of the busbar terminal 124 and ensures the installation position of the busbar terminal 124, so as to prevent displacement during usage that may affect or disable its function. In a usage scenario, when a user intends to remove the busbar terminal 124 from the second connector 120, the user may push the toggle latch 1325 to disengage the protruding portion 1326 from the inner surface 122si of the second housing 122. At this time, the plug 130 may be removed from the positioning slot SL, such that the busbar terminal 124 can be taken out from the second connector 120.

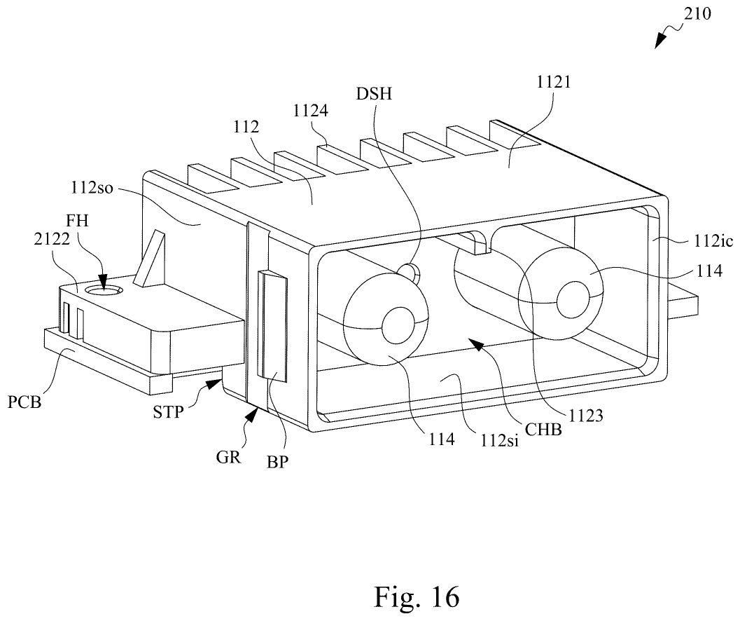

Reference is made to FIG. 16. FIG. 16 is a perspective view of a first connector 210 in accordance with an embodiment of the present disclosure. The first connector 210 can be coupled with the second connector 120 described in the aforementioned embodiment. The difference between the first connector 210 and the first connector 110 of the aforementioned embodiment is that the first connector 210 further includes a dimple DSH and a securing portion 2122. The dimple DSH is a recess located on an innermost wall of the chamber CHB (i.e., the partitioning wall between the chamber CHB and the recessed portion 1125), and serves as a positioning feature when the first connector 210 is coupled with the second connector 120 of the aforementioned embodiment. Compared with the securing portions 1122 of the first connector 110 in the aforementioned embodiment, the securing portion 2122 has an increased width along the mating direction or the securing portion 2122 is positioned further forward, such that a line perpendicular to the mating direction and passing through the center of gravity of the first connector 210 intersects both securing portions 2122. Alternatively, a transverse line at the midpoint along the mating direction of the first connector 210 (i.e., along the centerline perpendicular to the mating direction) passes through the portions of the securing portions 2122.

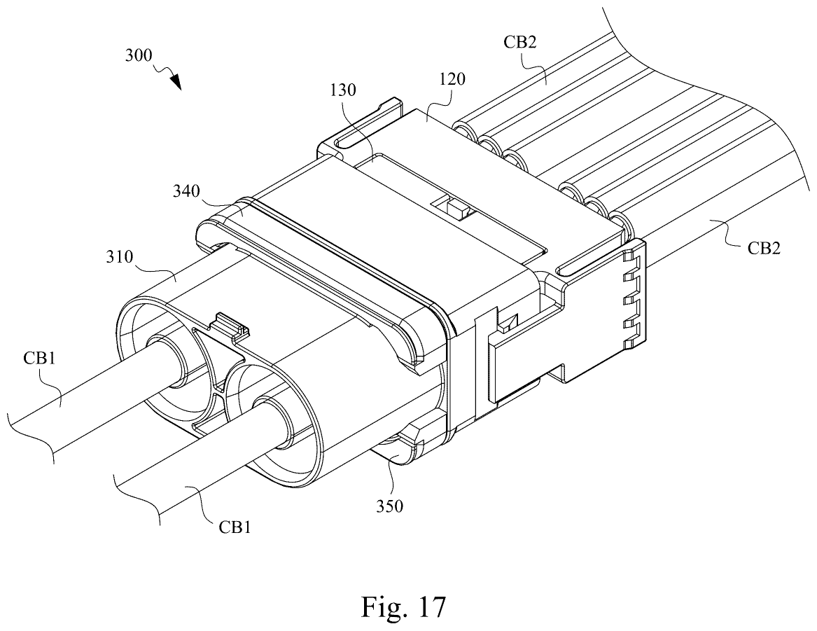

Reference is made to FIG. 17. FIG. 17 is a perspective view of a connector assembly 300 in accordance with an embodiment of the present disclosure. As shown in FIG. 17, in this embodiment, the connector assembly 300 includes a first connector 310 and a second connector 120, wherein the structure and functions of the second connector 120 are described above and will not be repeated here. The description will focus on the first connector 310. The first connector 310 is a cable end connector. The first connector 310 includes a plug 340 and a plug 350. A cable CB1 is connected to an end of the first connector 310 away from the second connector 120. A cable CB2 is connected to an end of the second connector 120 away from the first connector 310.

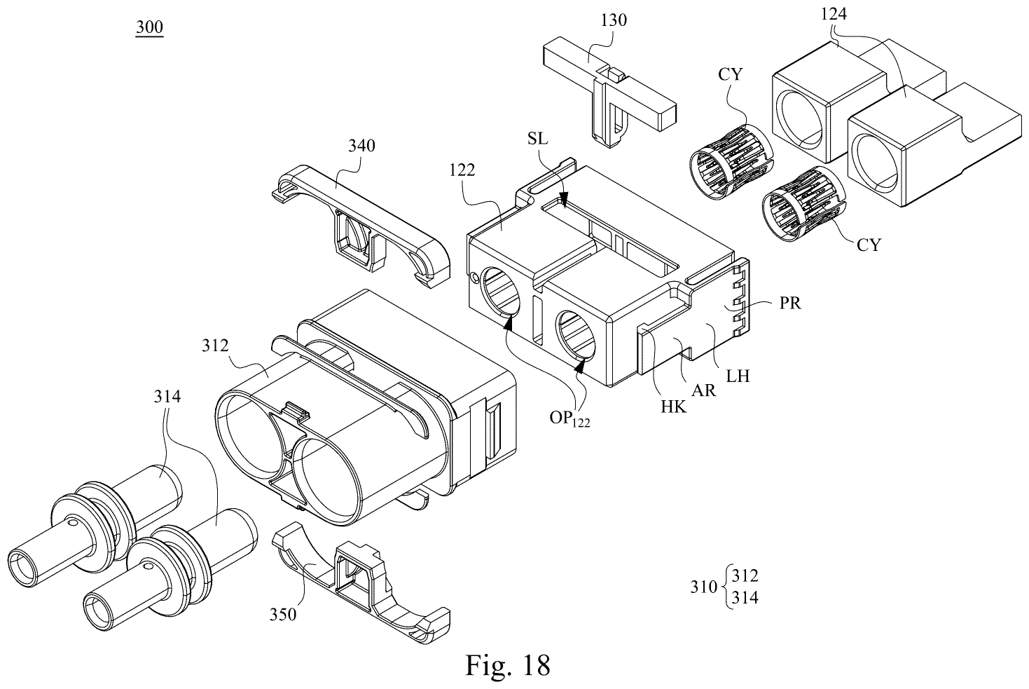

Reference is made to FIG. 18. FIG. 18 is an exploded view of a connector assembly 300 in accordance with an embodiment of the present disclosure. As shown in FIG. 18, in this embodiment, the first connector 310 includes a first housing 312 and a conductive terminal 314. The first housing 312 is configured to accommodate the conductive terminal 314.

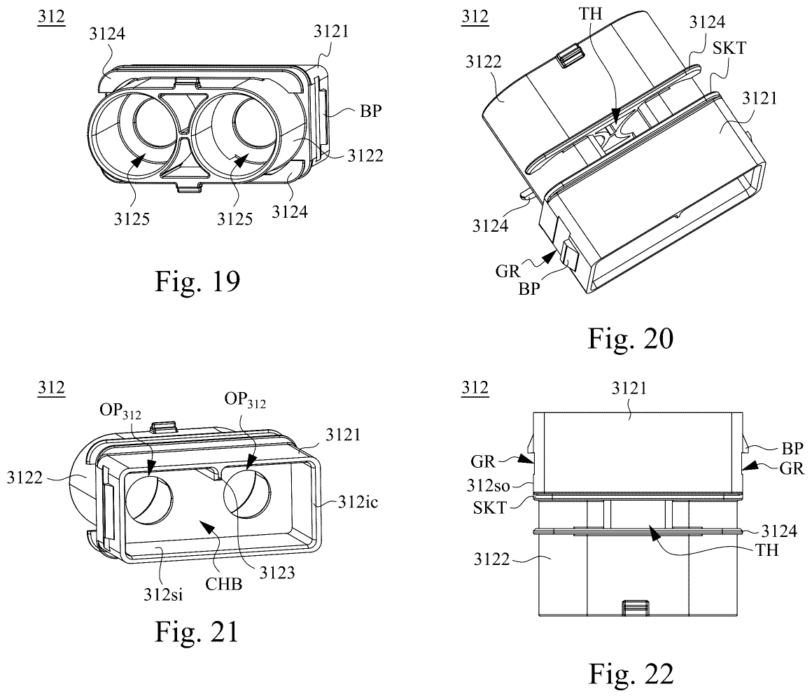

Reference is made to FIG. 19 to FIG. 22. FIG. 19 is a perspective view of a first housing 312 in accordance with an embodiment of the present disclosure. FIG. 20 is a perspective view of a first housing 312 in accordance with an embodiment of the present disclosure. FIG. 21 is a perspective view of a first housing 312 in accordance with an embodiment of the present disclosure. FIG. 22 is a top view of a first housing 312 in accordance with an embodiment of the present disclosure. As shown in FIG. 19 to FIG. 21, in this embodiment, the first housing 312 includes a first housing main body 3121, a tube body 3122, a guiding rail 3123, a cantilever 3124, a fringing portion SKT, and a first engaging structure BP. The first housing 312 further has a chamber CHB, a recessed portion 3125, an inserting hole TH, a groove GR, and an opening OP₃₁₂. The first housing main body 3121 is located at a front end of the first housing 312, and the tube body 3122 is located at a rear end of the first housing 312. The chamber CHB is located in the first housing main body 3121. The recessed portion 3125 is located in the tube body 3122. The recessed portion 3125 communicates with the chamber CHB via the opening OP₃₁₂. The guiding rail 3123 is disposed in the chamber CHB (i.e., an inner surface 312si of the first housing 312). The cantilever 3124 is disposed on an outer surface 312so of the first housing 312. The cantilever 3124 has a fixed end and a free end. The fringing portion SKT surrounds the first housing 312 and is separated from the cantilever 3124 to form a positioning groove therebetween. An inclined surface 312ic surrounds a periphery of an opening of the chamber CHB, and the inclined surface 312ic extends inward from an outermost edge of the opening. The inserting hole TH runs through the tube body 3122 and communicates with the recessed portion 3125. The inserting hole TH is located between the cantilever 3124 and the fringing portion SKT. The first engaging structure BP is disposed on the outer surface 312so of the first housing 312, such that the second housing 122 can be engaged with the first housing 312. As shown in FIG. 22, the groove GR is recessed from the outer surface 312so of the first housing 312 and is adjacent to the first engaging structure BP.

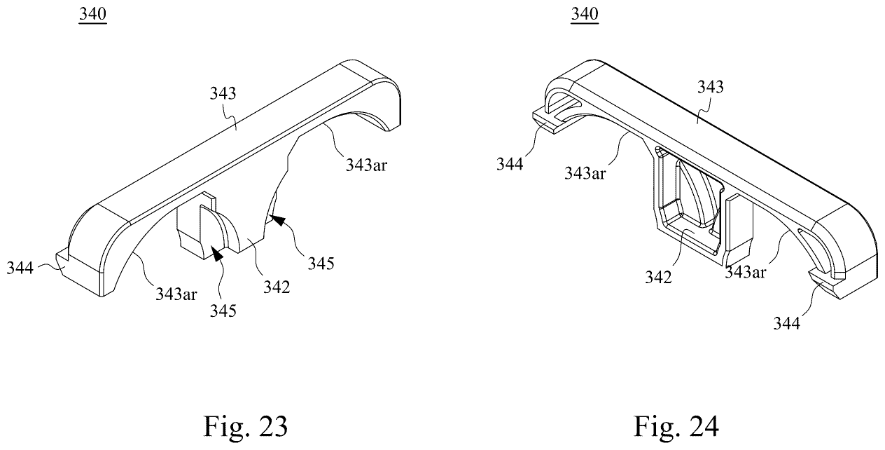

Reference is made to FIG. 23 and FIG. 24. FIG. 23 is a perspective view of a plug 340 in accordance with an embodiment of the present disclosure. FIG. 24 is a perspective view of a plug 340 in accordance with an embodiment of the present disclosure. Since the structure of the plug 350 is generally similar to that of the plug 340, only the plug 340 will be described in detail. As shown in FIG. 23 and FIG. 24, in this embodiment, the plug 340 includes an inserting portion 342, a cross bar 343, and a protruding portion 344. The inserting portion 342 protrudes from a middle section of the cross bar 343. The cross bar 343 has an arc surface 343ar that conforms to an outer surface of the tube body 3122. The protruding portion 344 is located at both ends of the cross bar 343 and protrudes from the cross bar 343. The plug 340 further includes an inner recessed portion 345 recessed from the inserting portion 342. In some embodiments, the inner recessed portion 345 conforms to a portion of the conductive terminal 314.

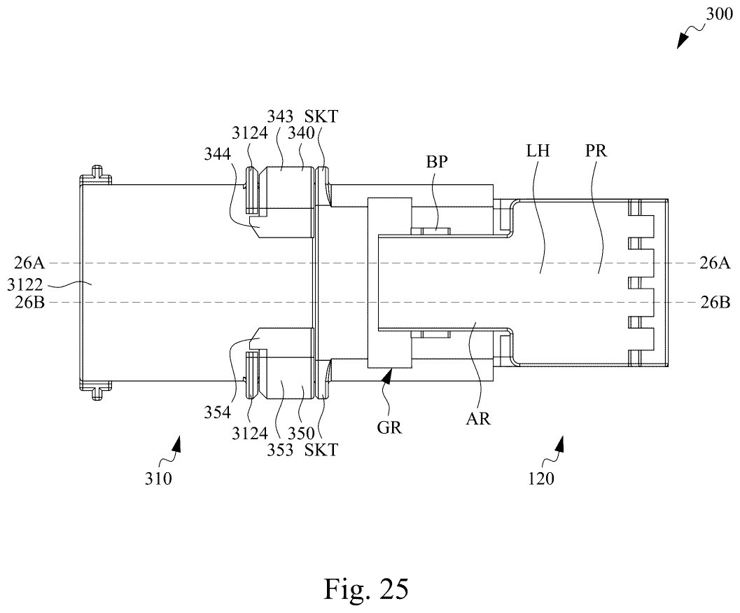

Reference is made to FIG. 25. FIG. 25 is a sided view of a connector assembly 300 in accordance with an embodiment of the present disclosure. When the plug 340 is inserted into the positioning slot, the cross bar 343 of the plug 340 is accommodated between the cantilever 3124 and the fringing portion SKT. The protruding portion 344 is engaged with a free end of the cantilever 3124. The cross bar 353 of the plug 350 is accommodated between the cantilever 3124 and the fringing portion SKT. The protruding portion 354 is engaged with the free end of the cantilever 3124. In this way, the plug 340 and the plug 350 are fixed to the first housing main body 3121. When a user intends to remove the plug 340 (or the plug 350), the user may deflect the free end of the cantilever 3124 to release the protruding portion 344 (or the protruding portion 354), allowing removal of the plug 340 (or the plug 350).

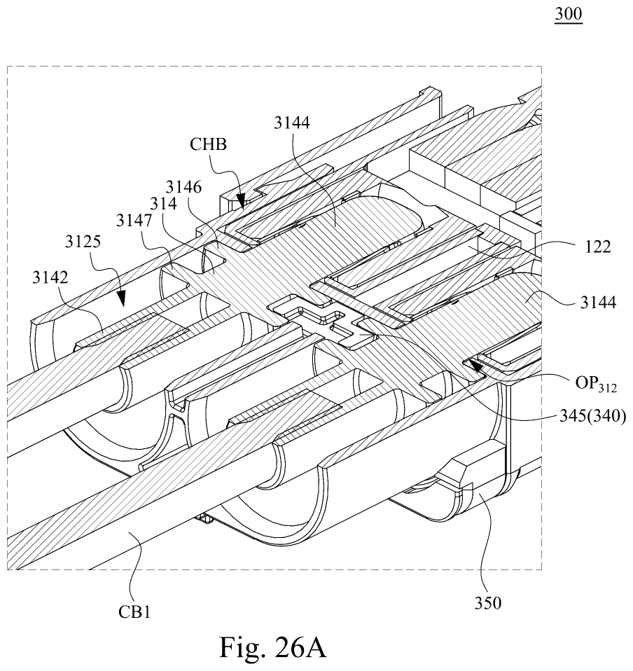

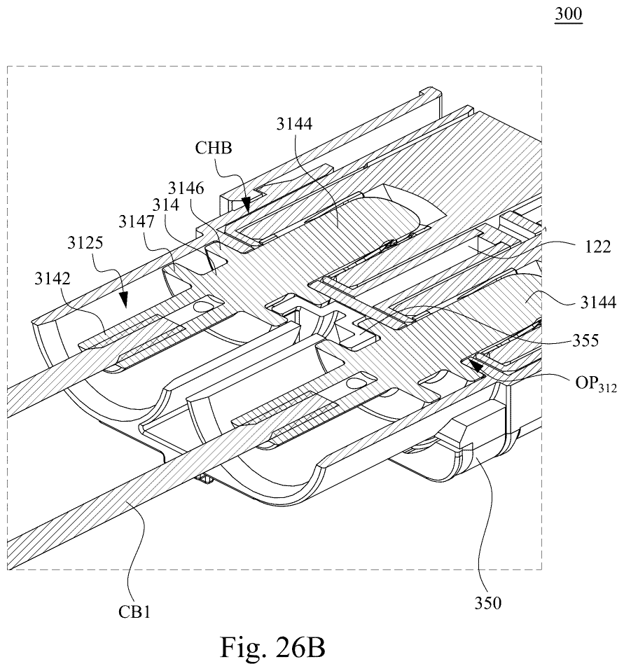

Reference is made to FIG. 26A and FIG. 26B. FIG. 26A and FIG. 26B are perspective cross-sectional views of the connector assembly 300 based on a section 26A-26A and a section 26B-26B of FIG. 25, respectively, in accordance with an embodiment of the present disclosure. In this embodiment, the conductive terminal 314 includes a rear end portion 3142, a front end portion 3144, a first convex ring 3146, and a second convex ring 3147. The rear end portion 3142 is located on a side of the conductive terminal 314 away from the second housing 122. The front end portion 3144 is connected to the rear end portion 3142 and is located on a side of the conductive terminal 314 close to the second housing 122. The first convex ring 3146 and the second convex ring 3147 surround the front end portion 3144 and are accommodated in the recessed portion 3125. The first convex ring 3146 and the second convex ring 3147 are separated from each other. The plug 340 is partially located between the first convex ring 3146 and the second convex ring 3147. In this embodiment, the inner recessed portion 345 of the plug 340 and the inner recessed portion 355 of the plug 350 are partially accommodated between the first convex ring 3146 and the second convex ring 3147, thereby positioning the conductive terminal 314 within the first housing 312. The rear end portion 3142 of the conductive terminal 314 is accommodated in the recessed portion 3125, and the front end portion 3144 passes through the opening OP₃₁₂ and is exposed in the chamber CHB.

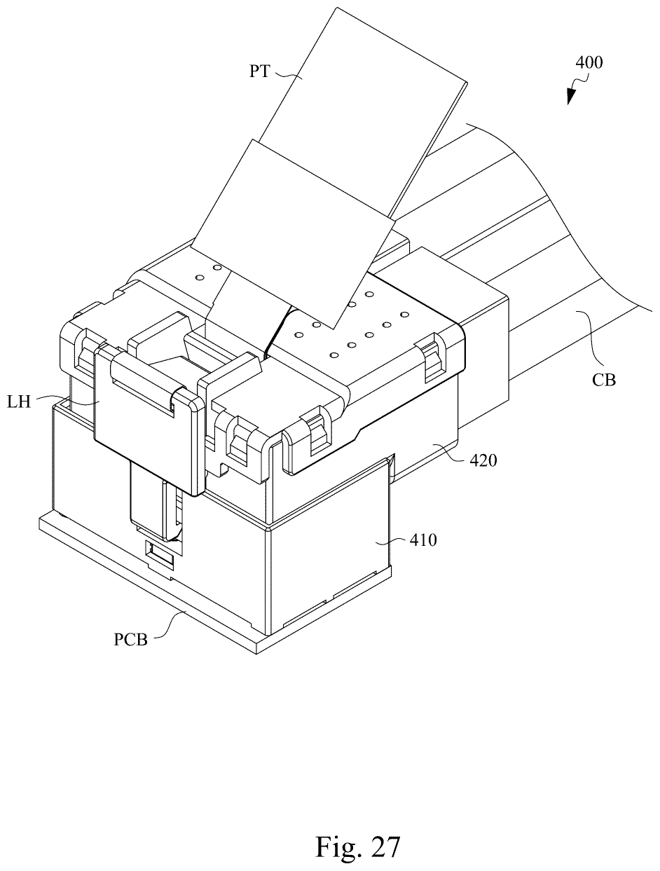

Reference is made to FIG. 27. FIG. 27 is a perspective view of a connector assembly 400 in accordance with an embodiment of the present disclosure. As shown in FIG. 27, in this embodiment, the connector assembly 400 includes a first connector 410 and a second connector 420. The first connector 410 is disposed on a circuit board PCB. The second connector 420 is coupled to the first connector 410 along a mating direction perpendicular to the circuit board PCB. The first connector 410 has a cavity configured to accommodate a portion of the second connector 420. The second connector 420 is engaged with the first connector 410. Specifically, the second connector 420 includes a second engaging structure LH, and the second connector 420 is engaged with a first engaging structure of the first connector 410 by the second engaging structure LH. A cable CB is connected to the second connector 420.

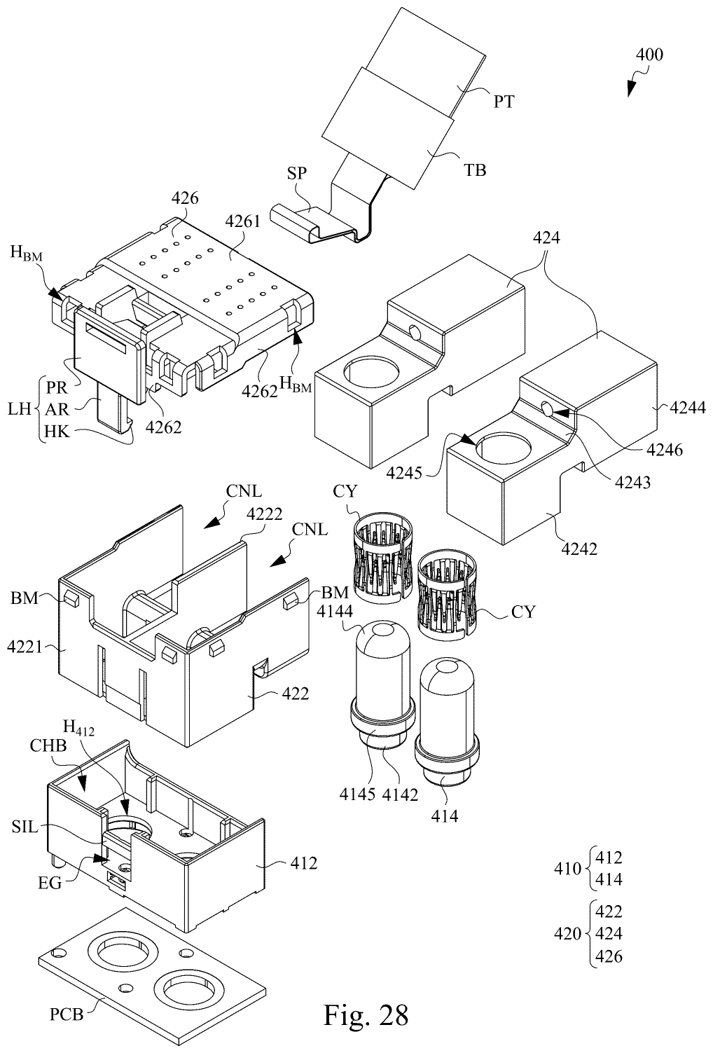

Reference is made to FIG. 28. FIG. 28 is an exploded view of a connector assembly 400 in accordance with an embodiment of the present disclosure. As shown in FIG. 28, in this embodiment, the first connector 410 includes a first housing 412 and a conductive terminal 414. The first housing 412 has a chamber CHB, a perforation H₄₁₂ that runs through the first housing 412 and communicates with the chamber CHB, and an engaging hole EG. The perforation H₄₁₂ and the engaging hole EG are located on different surfaces of the first housing 412. The first connector 410 further includes a first engaging structure. In this embodiment, the first engaging structure is a sill SIL. The sill SIL is connected to the first housing 412 and defines one side of the engaging hole EG. The conductive terminal 414 is partially located in the chamber CHB of the first housing 412 and passes through the perforation H₄₁₂. The conductive terminal 414 includes a rear end portion 4142, a front end portion 4144, and a convex ring 4145. The front end portion 4144 is connected to the rear end portion 4142. The convex ring 4145 is connected with the rear end portion 4142 and the front end portion 4144. The convex ring 4145 is located between the rear end portion 4142 and the front end portion 4144. The convex ring 4145 surrounds the front end portion 4144.

The second connector 420 includes a second housing 422, a busbar terminal 424, and a cover body 426. The second housing 422 includes a first portion and a second portion connected to the first portion. The second portion extends perpendicularly from the first portion, such that the second housing 422 has a substantially L shape. The second housing 422 includes a second housing main body 4221, a partitioning wall 4222, and a bump BM. The partitioning wall 4222 is connected to the second housing main body 4221 and divides the second housing 422 into a plurality of channels CNL. The channels CNL extend in both the first portion and the second portion of the second housing 422. The bump BM is disposed on a side plate of the first housing 412. The busbar terminal 424 is located in the channel CNL of the second housing 422 and is configured to be connected to the cable CB. The busbar terminal 424 includes a coupling portion 4242, a stepping portion 4243, and a connecting portion 4244. The coupling portion 4242 has an accommodating slot 4245 configured to receive the conductive terminal 414 and achieve electrical connection with the conductive terminal 414. The cover body 426 is engaged with the second housing 422. The cover body 426 includes a cover main body 4261 and a latching portion 4262. The latching portion 4262 extends outward from a side of the cover main body 4261. The cover main body 4261 has a perforation H_{BM}. The second engaging structure LH is disposed on the cover body 426, and the second engaging structure LH includes an elastic arm AR, a pressing portion PR located at an end of the elastic arm AR, and a hook HK located at the other end of the elastic arm AR. The hook HK is able to be engaged with the engaging hole EG.

The connector assembly 400 may further include a pull tab PT disposed on the second connector 420. An end of the pull tab PT is fixed to the pressing portion PR of the second engaging structure LH and is movably connected to the cover body 426. Specifically, the pull tab PT includes a strip portion SP and a tab portion TB, and the strip portion SP is fixed to the pressing portion PR. The connector assembly 400 further includes a crown band CY located in the accommodating slot 4245 of the busbar terminal 424.

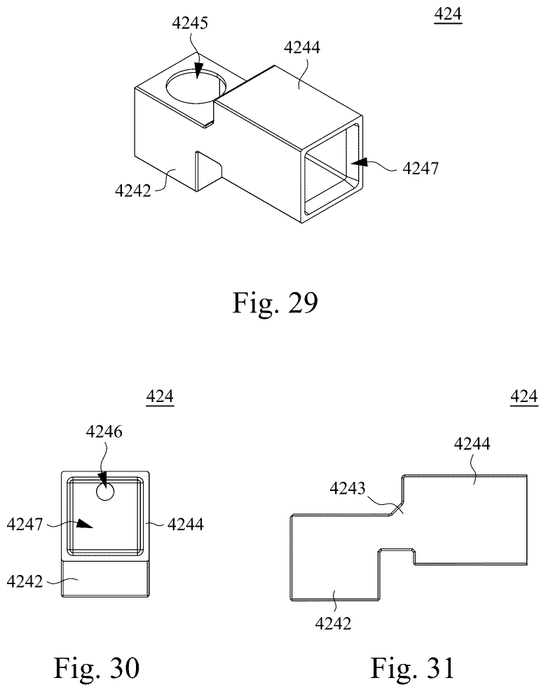

Reference is made to FIG. 29 to FIG. 31. FIG. 29 is a perspective view of a busbar terminal 424 in accordance with an embodiment of the present disclosure. FIG. 30 is a rear view of a busbar terminal in accordance with an embodiment of the present disclosure. FIG. 31 is a sided view of a busbar terminal in accordance with an embodiment of the present disclosure. As shown in FIG. 29 and FIG. 30, the busbar terminal 424 further has a cable slot 4247 configured to accommodate the cable CB. The cable slot 4247 is located in the connecting portion 4244, and the cable slot 4247 has an opening, such that a portion of the cable CB enters the cable slot 4247 via the opening. The accommodating slot 4245 has a cylindrical shape and extends along the aforementioned mating direction. The cable slot 4247 extends along a direction perpendicular to the aforementioned mating direction. A through hole 4246 passes from the stepping portion 4243 to the cable slot 4247 and serves as a liquid flow hole for plating liquid during electroplating of the cable slot 4247. As shown in FIG. 31, the stepping portion 4243 is connected with the coupling portion 4242 and the connecting portion 4244, and the stepping portion 4243 is located between the coupling portion 4242 and the connecting portion 4244. In some embodiments, a top surface of the connecting portion 4244 is higher than a top surface of the coupling portion 4242.

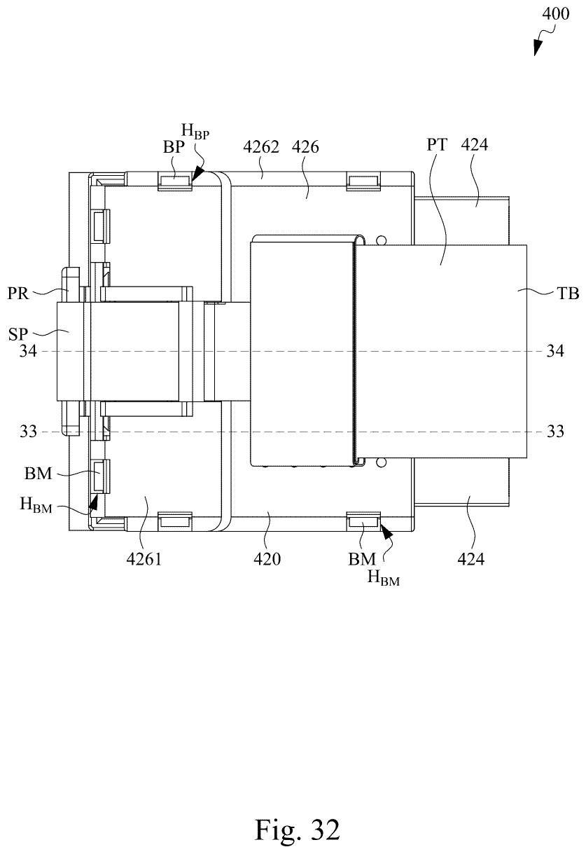

Reference is made to FIG. 32. FIG. 32 is a top view of a connector assembly 400 in accordance with an embodiment of the present disclosure. As shown in FIG. 32, the perforation H_{BM} of the latching portion 4262 of the cover body 426 is engaged with the bump BM. Specifically, the latching portion 4262 is connected to three sides of the cover main body 4261, and each side includes a perforation H_{BM}. Multiple bumps BM correspond to the multiple perforations H_{BM}.

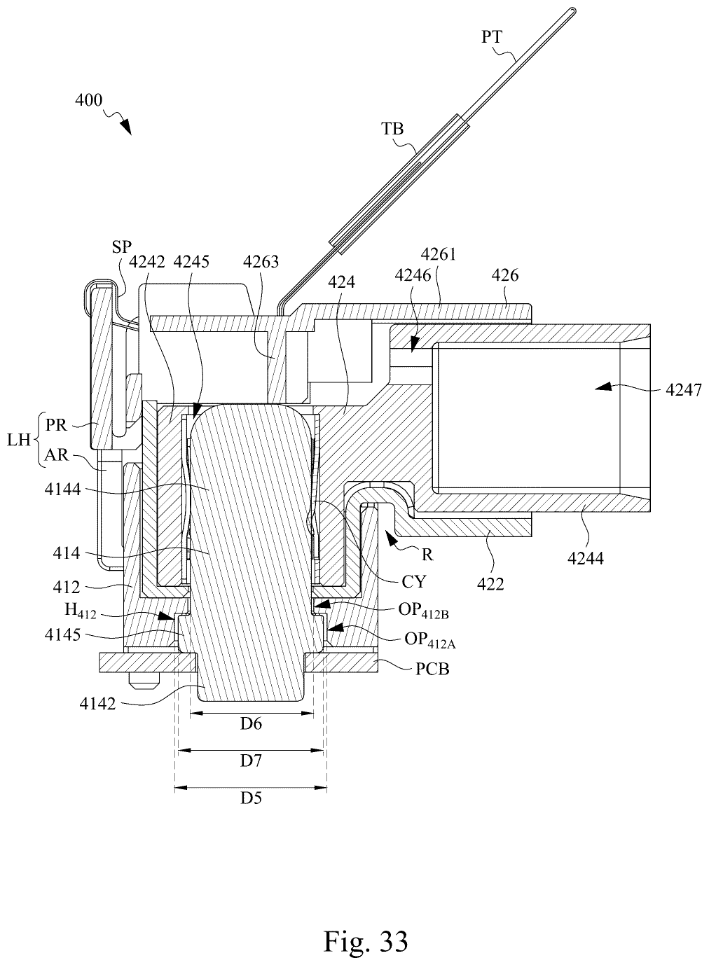

Reference is made to FIG. 33. FIG. 33 is a cross-sectional view of the connector assembly 400 based on a section 33-33 of FIG. 32 in accordance with an embodiment of the present disclosure. As shown in FIG. 33, the second housing 422 further has an indentation portion R. The indentation portion R is recessed from an outer surface of the second housing 422 and located between the first portion and the second portion. The first housing 412 is partially located in the indentation portion R. This reduces the height of the connector assembly 400 relative to the circuit board PCB, achieving a space-saving effect. A portion of the busbar terminal 424 may extend beyond the cover body 426 and the second housing 422. The crown band CY sleeves around the front end portion 4144 and located in the accommodating slot 4245. The cover body 426 further includes an abutting portion 4263 that abuts against the front end portion 4144 of the conductive terminal 414. This helps the positioning of the busbar terminal 424. In some embodiments, the abutting portion 4263 extends perpendicularly from the cover main body 4261.

The perforation H₄₁₂ of the first housing 412 has an opening OP_{412A} and an opening OP_{412B} respectively located at two ends of the perforation H₄₁₂. The opening OP_{412A} is located at an end of the perforation H₄₁₂ close to the circuit board PCB, and the opening OP_{412B} is located at an end of the perforation H₄₁₂ close to the chamber CHB. The opening OP_{412A} has a diameter D5. The opening OP_{412B} has a diameter D6. The convex ring 4145 of the conductive terminal 414 has a maximum diameter D7. The diameter D7 is slightly less than the diameter D5, and the diameter D7 is greater than the diameter D6, such that the convex ring 4145 of the conductive terminal 414 is installable and constrained within the perforation H₄₁₂. In some embodiments, the maximum diameter D7 is equal to or slightly greater than the diameter D6. This allows an interference fit between the convex ring 4145 and the perforation H₄₁₂ for fixation when the convex ring 4145 of the conductive terminal 414 is installed in the perforation H₄₁₂.

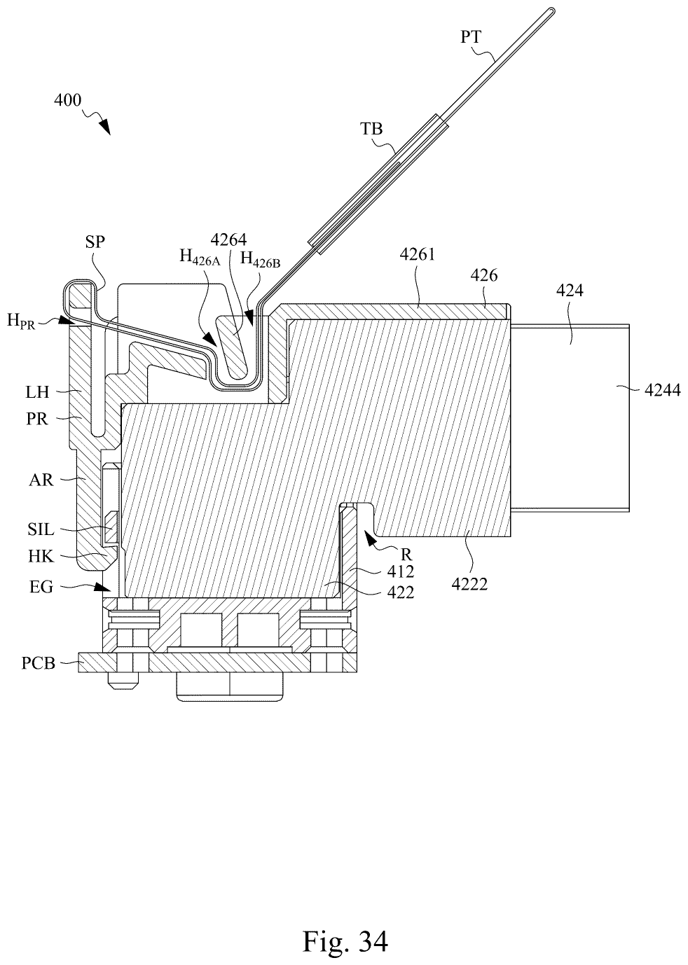

Reference is made to FIG. 34. FIG. 34 is a cross-sectional view of the connector assembly 400 based on a section 34-34 of FIG. 32 in accordance with an embodiment of the present disclosure. As shown in FIG. 34, in this embodiment, the cover body 426 further includes a pull tab guiding portion for guiding the movement of the pull tab PT. The pull tab guiding portion includes a guiding beam 4264 that redirects a portion of the pull tab PT, which is within the pull tab guiding portion, to form at least two segments with different extending directions. The guiding beam 4264 separates the pull tab guiding portion into two communicating spaces: a perforation H_{426A} and a perforation H_{426B}. The pressing portion PR of the second engaging structure LH has a perforation H_{PR}. An end of the strip portion SP passes through the perforation H_{PR} and loops around the pressing portion PR. A middle section of the strip portion SP passes through the pull tab guiding portion. That is, the strip portion SP enters into the perforation H_{426A} from an upper surface of a cover main body 4261, extends below the guiding beam 4264, and exits via the perforation H_{426B}. In other words, part of the pull tab PT (e.g. the strip portion SP) is located between the guiding beam 4264 and the cover main body 4261. The tab portion TB is located outside the second connector 420. In a usage scenario, when the user intends to detach the second connector 420 from the first connector 410, the user may hold the second connector 420 and simultaneously pull the pull tab PT. Specifically, while holding the second connector 420, the user can pull the tab portion TB with a finger, thereby driving the strip portion SP to move the pressing portion PR. Next, the elastic arm AR seesaws relative to an outer surface of the second housing 422, causing the pressing portion PR to move toward the outer surface of the second housing 422 and the hook HK to move away from the outer surface of the second housing 422. Thus, the hook HK disengages from the sill SIL and exits the engaging hole EG, allowing the user to more easily detach the second connector 420 from the first connector 410.

From the above detailed description of the specific embodiments of the present disclosure, it can be clearly seen that in the connector assembly of the present disclosure, since the second engaging structure located on the second housing is engaged with the first engaging structure located on the first housing, the first connector and the second connector can be coupled to each other. In the connector assembly of the present disclosure, since the first plug is inserted into the positioning slot of the second housing and abuts against the busbar terminal, and the height of the coupling portion of the busbar terminal is greater than the height of the connecting portion, the busbar terminal is blocked by the first plug, thereby preventing the user from unintentionally pulling the busbar terminal coupled to the cable out of the second housing. In the connector assembly of the present disclosure, since the second plug is inserted into the inserting hole of the first housing and is partially located between the first convex ring and the second convex ring of the conductive terminal, the conductive terminal is blocked by the second plug, thereby preventing the user from unintentionally pulling the conductive terminal coupled to the cable out of the first housing. In the connector assembly of the present disclosure, since the step is formed at the bottom portion of the first housing, the circuit board can be partially accommodated in a recess formed by the step, thereby reducing the height of the connector assembly relative to the circuit board and achieving a space-saving effect. In the connector assembly of the present disclosure, since the end of the pull tab is fixed to the pressing portion of the second engaging structure, and the second engaging structure is disposed on the cover body of the second housing, when the user intends to remove the second connector from the first connector, the second engaging structure can be disengaged from the engaging hole located on the first housing by pulling the pull tab, therefore it is more convenient to disconnect the two connectors. In the connector assembly of the present disclosure, since the busbar terminal includes the stepping portion connected to and located between the coupling portion and the connecting portion, the stress applied to the busbar terminal can be reduced, thereby enhancing the structural strength of the busbar terminal. Overall, the connector assembly of the present disclosure can achieve ease of operation and provide a stable structure for the entire connector assembly.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector assembly, comprising:
a first connector, comprising:
a first housing having a chamber;
a conductive terminal comprising a cylindrical structure, and the cylindrical structure being partially located in the chamber of the first housing; and
a first engaging structure disposed on an outer surface of the first housing;
a second connector configured to be coupled to the first connector along a mating direction, the second connector comprising:
a second housing being able to be partially accommodated in the chamber and having a channel and a positioning slot communicating with the channel;
a busbar terminal located in the channel of the second housing and comprising a coupling portion, a stepping portion, and a connecting portion, the coupling portion having an accommodating slot, the conductive terminal passing through the accommodating slot of the busbar terminal, the connecting portion being plate-shaped, and the stepping portion being located between the coupling portion and the connecting portion; and
a second engaging structure engaged with the first engaging structure; and
a first plug located in the positioning slot and adjacent to the stepping portion.

2. The connector assembly of claim 1, wherein the first housing further comprises a securing portion located on two sides of the first housing, and the securing portion has a securing hole.

3. The connector assembly of claim 1, wherein the first housing further comprises a securing portion located on two sides of the first housing, a portion of the securing portion is located on a centerline of the first housing, and the centerline is perpendicular to the mating direction.

4. The connector assembly of claim 1, wherein the first housing further has a recessed portion communicating with the chamber, and the conductive terminal comprises:
a middle portion located in the recessed portion of the first housing and having a guiding furrow, and the cylindrical structure extending from the middle portion along the mating direction; and
a pin disposed on the middle portion.

5. The connector assembly of claim 4, wherein the first housing further comprises a guiding stick located in the recessed portion, and the guiding stick is located in the guiding furrow of the middle portion.

6. The connector assembly of claim 1, wherein the stepping portion has an inclined surface.

7. The connector assembly of claim 1, wherein the first plug comprises:
a cross bar accommodated in the positioning slot and blocking the busbar terminal;
an elastic portion protruding from a middle section of the cross bar and comprising a fixed portion connected to the cross bar, a free portion connected to the fixed portion, a toggle latch disposed at an end of the free portion, and a protruding portion disposed on the toggle latch and located on a side of the free portion away from the fixed portion, wherein the protruding portion is engaged with an inner surface of the second housing; and
a bulge disposed on a side of the fixed portion of the elastic portion away from the free portion and protruding from the fixed portion,
wherein the fixed portion and the free portion extend in parallel and the fixed portion and the free portion define a space therebetween.

8. The connector assembly of claim 1, further comprising a second plug located in an inserting hole of the first housing and abutting against the conductive terminal.

9. The connector assembly of claim 8, wherein the first housing comprises a first housing main body and a tube body connected to the first housing main body, the chamber being located in the first housing main body, and the first housing further having a recessed portion located in the tube body, and wherein the inserting hole runs through the tube body and communicates with the recessed portion.

10. The connector assembly of claim 8, wherein the conductive terminal further comprises:
a rear end portion located on a side of the conductive terminal away from the second housing;
a front end portion comprising the cylindrical structure and connected to the rear end portion, and the front end portion being located on a side of the conductive terminal close to the second housing; and
a first convex ring and a second convex ring surrounding the front end portion, and the first convex ring and the second convex ring being separated from each other,
wherein the second plug is partially located between the first convex ring and the second convex ring.

11. The connector assembly of claim 8, wherein the first housing further comprises:
a cantilever disposed on the outer surface of the first housing and comprising a fixed end and a free end; and
a fringing portion surrounding the first housing and separated from the cantilever,
wherein the inserting hole is located between the cantilever and the fringing portion.

12. The connector assembly of claim 11, wherein the second plug comprises:
a cross bar accommodated between the cantilever and the fringing portion;
an inserting portion protruding from a middle section of the cross bar and passing through the inserting hole; and
a protruding portion located at both ends of the cross bar and protruding from the cross bar, and the protruding portion being engaged with the free end of the cantilever.

13. The connector assembly of claim 1, wherein the second housing further comprises a cover body, and the second engaging structure is located on the cover body.

14. A cable end connector, comprising:
a housing comprising a first portion accommodated in a chamber and a second portion extending perpendicularly from the first portion;
a terminal located in the housing;
a cover body engaged with the housing; and
an engaging structure disposed on the cover body and comprising an elastic arm capable of seesawing relative to an outer surface of the housing and a hook located at an end of the elastic arm.

15. The cable end connector of claim 14, further comprising a pull tab connected to the cover body, and an end of the pull tab is connected to the engaging structure.

16. The cable end connector of claim 15, wherein the cover body comprises a pull tab guiding portion, and the pull tab passes through the pull tab guiding portion to form at least two segments extending in different directions.

17. The cable end connector of claim 16, wherein the cover body comprises a guiding beam separating the pull tab guiding portion into a first perforation and a second perforation, and wherein a strip portion of the pull tab enters into the first perforation from an upper surface of the cover body, extends below the guiding beam, and exits via the second perforation.

18. The cable end connector of claim 15, wherein the cover body comprises a guiding beam, and part of the pull tab extends below the guiding beam.

19. The cable end connector of claim 14, wherein the terminal comprises a coupling portion, a stepping portion, and a connecting portion, the stepping portion is connected to the coupling portion and the connecting portion, the stepping portion is located between the coupling portion and the connecting portion, the coupling portion has an accommodating slot, and a top surface of the connecting portion is higher than a top surface of the coupling portion.

20. The cable end connector of claim 19, wherein the connecting portion has a cable slot, and the cable slot has an opening such that a portion of a cable is capable of entering the cable slot through the opening.
